(19) United States
(12) Patent Application Publication
(10) Pub. No.: US 2025/0278795 A1
(43) Pub. Date: Sep. 4, 2025

(54) METHOD AND SYSTEM FOR AUDITING TO DETECT TRANSACTION SPLITTING ACTIVITIES

(71) Applicant: JACKSOFT COMMERCE AUTOMATION LTD., Chiayi City (TW)

(72) Inventor: Hsiu-Feng Huang, Chiayi City (TW)

(73) Assignee: JACKSOFT COMMERCE AUTOMATION LTD., Chiayi City (TW)

(21) Appl. No.: 18/775,554

(22) Filed: Jul. 17, 2024

(30) Foreign Application Priority Data
Feb. 29, 2024 (TW) 113107318

(51) Int. Cl. G06Q 40/12

(52) U.S. Cl. CPC G06Q 40/12

(57) ABSTRACT

A method for auditing to detect transaction splitting activities is related to a plurality of entries of accounting data each including at least a transaction information sub-entry and a time sub-entry. The method includes: performing a sorting operation on the accounting data based on the time sub-entries, so as to create a sorted list of accounting data; performing a grouping operation on the sorted list of accounting data, based on at least one grouping parameter, so as to obtain a plurality of groups of accounting data; and with respect to each of the groups, when the entries of accounting data included in the group indicate a date gap smaller than a predetermined time threshold, tagging the group as a candidate group, and tagging each of the entries of accounting data in the group as a potential split entry.

### CROSS-REFERENCE TO RELATED APPLICATION

This application claims priority to Taiwanese Invention patent application No. 113107318, filed on Feb. 29, 2024, the entire disclosure of which is incorporated by reference herein.

### FIELD

The disclosure relates to a method and a system for data processing, and more particularly to a method and a system for auditing to detect transaction splitting activities.

### BACKGROUND

In the field of auditing, the practice of order splitting or transaction splitting activities typically refers to splitting a larger order (e.g., a purchase order) into a plurality of smaller orders. This practice may be adopted in the procurement transactions by enterprises or institutions for fraudulent purposes or in an attempt to evade regulatory supervisions, and includes a number of different applications. For example, employees of enterprises or institutions may attempt to break up a large order that was originally approved by the management into a plurality of smaller orders, so as to evade the corresponding inspection process. Moreover, by splitting a large order into smaller orders that are associated with smaller monetary amounts, the bidding process that may otherwise be required for the larger order may be avoided, since smaller orders typically do not require a bidding process.

Currently in auditing, to detect the practice of transaction splitting, random samples of the records of procurement transactions by enterprises or institutions may be chosen and manually inspected (by, for example, an auditing agency or a government agency). Alternatively, in response to receipt of tips of potential abnormal transactions, the records of the associated procurement transactions may be chosen and manually inspected.

### SUMMARY

It is noted that the records of procurement transactions by enterprises or institutions are typically complex and large in size, and therefore efficient manual auditing thereof may not be possible.

Therefore, one object of the disclosure is to provide a method for auditing to detect transaction splitting activities.

According to one embodiment of the disclosure, the method is implemented using a system that includes a processor and a data storage. The data storage storing a plurality of entries of accounting data therein. Each of the plurality of entries of accounting data including at least a transaction information sub-entry and a time sub-entry. The method includes:
a) performing, by the processor, a sorting operation on the plurality of entries of accounting data stored in the data storage based on the time sub-entry, so as to create a sorted list of accounting data;
b) performing, by the processor, a grouping operation on the sorted list of accounting data, based on at least one grouping parameter and the transaction information sub-entries of the plurality of entries of accounting data, so as to obtain a plurality of groups of accounting data; and
c) with respect to each of the groups, by the processor, determining whether the entries of accounting data included in the group indicate a date gap smaller than a predetermined time threshold, and in a case where the entries of accounting data included in the group indicate a date gap smaller than the predetermined time threshold, tagging the group as a candidate group, and tagging each of the entries of accounting data included in the candidate group as a potential split entry.

Another object of the disclosure is to provide a system that is configured to implement the above-mentioned method.

According to one embodiment of the disclosure, the system includes a processor and a data storage connected to the processor. The data storage stores a plurality of entries of accounting data therein. Each of the plurality of entries of accounting data including at least a transaction information sub-entry and a time sub-entry. The processor is programmed to:
perform a sorting operation on the plurality of entries of accounting data stored in the data storage based on the time sub-entries of the plurality of entries of accounting data, so as to create a sorted list of accounting data;
perform a grouping operation on the sorted list of accounting data, based on at least one grouping parameter and the transaction information sub-entries of the plurality of entries of accounting data, so as to obtain a plurality of groups of accounting data; and
with respect to each of the groups, determine whether the entries of accounting data included in the group indicate a date gap smaller than a predetermined time threshold, and in a case where the entries of accounting data included in the group indicate a date gap smaller than the predetermined time threshold, tag the group as a candidate group, and tag each of the entries of accounting data included in the candidate group as a potential split entry.

### BRIEF DESCRIPTION OF THE DRAWINGS

Other features and advantages of the disclosure will become apparent in the following detailed description of the embodiment(s) with reference to the accompanying drawings. It is noted that various features may not be drawn to scale.

FIG. 1 is a block diagram illustrating a system for auditing to detect transaction splitting activities according to one embodiment of the disclosure.

FIG. 2 is a flow chart illustrating steps of an exemplary method for auditing to detect transaction splitting activities according to one embodiment of the disclosure.

FIG. 3 is a flow chart illustrating exemplary sub-steps of operations of step 23 in FIG. 2 according to one embodiment of the disclosure.

FIG. 4 is a flow chart illustrating exemplary sub-steps of operations of step 24 in FIG. 2 according to one embodiment of the disclosure.

FIG. 5 is a flow chart illustrating exemplary sub-steps of operations of step 24′ in FIG. 2 according to one embodiment of the disclosure.

FIG. 6 illustrates an exemplary graphical user interface that may be displayed by a display according to one embodiment of the disclosure.

### DETAILED DESCRIPTION

Before the disclosure is described in greater detail, it should be noted that where considered appropriate, reference numerals or terminal portions of reference numerals have been repeated among the figures to indicate corresponding or analogous elements, which may optionally have similar characteristics.

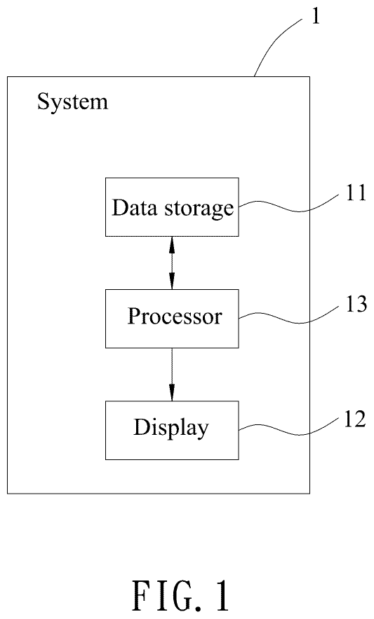

FIG. 1 is a block diagram illustrating a system 1 for auditing to detect transaction splitting activities according to one embodiment of the disclosure. In this embodiment, the system 1 may be embodied using a computer device, a server, or other suitable electronic devices.

In this embodiment, the system 1 is embodied using a server and includes a data storage 11, a display 12, and a processor 13.

The data storage 11 may be embodied using, for example, random access memory (RAM), read only memory (ROM), programmable ROM (PROM), firmware, flash memory, etc. In this embodiment, the data storage 11 stores therein a software application and a number (N) of entries of accounting data. The software application includes instructions that, when executed by the processor 13, cause the processor 13 to implement the operations as described below. In embodiments, the software application may be a computer-assisted audit tool (CAATs) application. Each of the (N) entries of accounting data may be related to a transaction, and includes at least a transaction information sub-entry, a time sub-entry, and a transaction amount sub-entry.

The transaction information sub-entry may include various information related to the transaction, such as a code name of a party involved in the transaction (e.g., a vendor number), a code name of a part (or parts) or a product (or products) involved in the transaction (e.g., a part number), an Internet Protocol (IP) address of the party involved in the transaction, a code name of a department of another party involved in the transaction (e.g., an enterprise that purchased the part or the product), etc. The time sub-entry may include various information concerning time related to the transaction, such as an ordering time when an order was placed, a transaction time when money was transferred, a delivering time when the part(s) or the product(s) was (were) delivered, etc. In embodiments, the time may be represented in the form of a date, but is not limited as such. The transaction amount sub-entry may include a transaction amount excluding tax, a transaction amount including tax, a network traffic amount, an amount or quantity of the part or the product involved in the transaction, etc.

In different embodiments, the content of each sub-entry included in the entries of the accounting data may vary to accommodate different applications. For example, in a case where it is desired to prevent a salesperson from performing transaction splitting by which a large order is broken into a number of smaller orders that each have a transaction amount greater than a predetermined threshold associated with a sales bonus, the transaction information sub-entry may include the code name of a party involved in the transaction (e.g., the vendor), and the transaction amount sub-entry may include the transaction amount excluding tax and/or the transaction amount including tax. In a case where it is desired to prevent employees of an organization or a company from leaking classified information using smaller orders, the transaction information sub-entry may include the IP address, and the transaction amount sub-entry may include the network traffic amount. In a case where it is desired to prevent accumulated inventory due to excessive purchasing within a short time period from happening, the transaction information sub-entry may include the code name of a part (or parts) or a product (or products) involved in the transaction, and the transaction amount sub-entry may include the amount of the part(s) or the product(s) involved in the transaction.

The processor 13 may be embodied using a central processing unit (CPU), a microprocessor, a microcontroller, a single core processor, a multi-core processor, a dual-core mobile processor, a microprocessor, a microcontroller, a digital signal processor (DSP), a field-programmable gate array (FPGA), an application specific integrated circuit (ASIC), and/or a radio-frequency integrated circuit (RFIC), etc.

The display 12 is connected to the processor 13, and may be embodied using a physical display screen. In use, the display 12 may be controlled by the processor 13 to display various information.

In embodiments, when it is desired to perform an audit operation using the number (N) of entries of accounting data stored in the data storage 11, a user of the system 1 may operate the system 1 to execute the software application stored in the data storage 11, so as to initiate a method for auditing to detect transaction splitting activities.

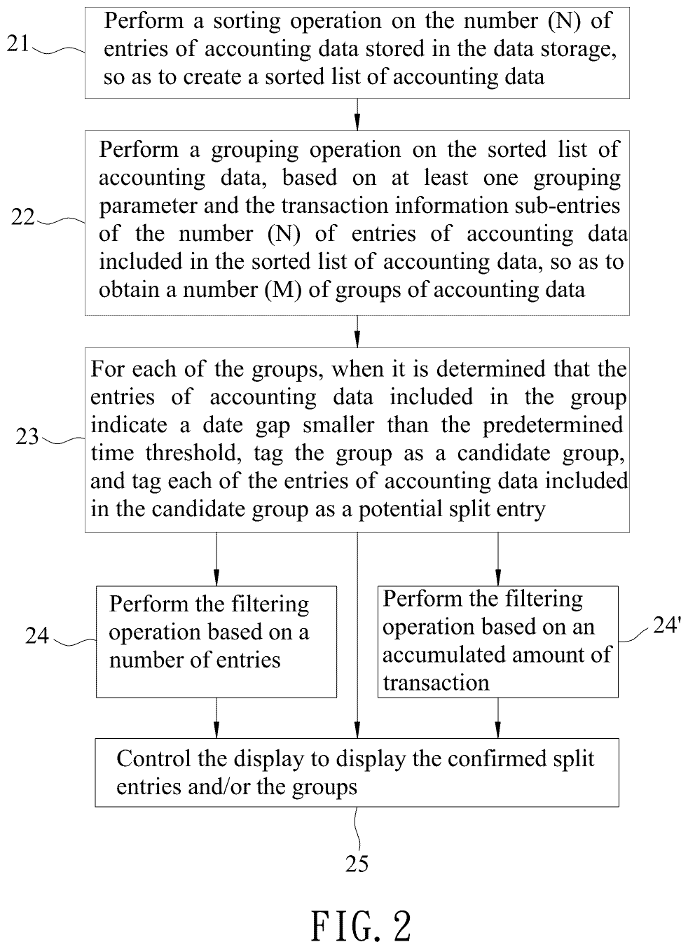

FIG. 2 is a flow chart illustrating steps of an exemplary method for auditing to detect transaction splitting activities according to one embodiment of the disclosure.

In step 21, the processor 13 performs a sorting operation on the number (N) of entries of accounting data stored in the data storage 11, so as to create a sorted list of accounting data. Specifically, in this embodiment, the processor 13 employs a QuickSort algorithm to sort the number (N) of entries of accounting data based on the time sub-entries (e.g., the transaction time) thereof. The sorted list of accounting data may be presented in an ascending manner or a descending manner.

It is noted that in other embodiments, the sorting operation may be performed to first sort the number (N) of entries of accounting data based on other data included in the sub-entries (e.g., the code name of the vendor, the part number, the code name of the department, the IP address, etc.). That is to say, the sorting operations may include a plurality of sorting actions with respect to various parameters. For instance, the sorting actions may be performed with respect to English alphabets, numbers, etc. In embodiments, after the above operations are performed, a final operation to sort the number (N) of entries of accounting data based on the time sub-entry will be performed.

Then, in step 22, the processor 13 performs a grouping operation on the sorted list of accounting data, based on at least one grouping parameter and the transaction information sub-entries of the number (N) of entries of accounting data included in the sorted list of accounting data, so as to obtain a number (M) of groups of accounting data. Each of the groups of accounting data includes a number (Nₘ) of entries of accounting data, and M>1, N≥Nₘ≥1, m={2, 3, . . . , M}. In embodiments, the grouping parameter may be the party involved in the transaction, the product, the department of the enterprise, the time of the transaction (e.g., the time of delivery), etc. That is to say, in performing the grouping operation, the processor 13 may aggregate entries of accounting data that indicate the same code name for the party involved in the transaction into a same group. Alternatively, the processor 13 may aggregate entries of accounting data that indicate the same department of the enterprise involved in the transaction, the same product, or the same date of transaction into a same group.

In some embodiments, a plurality of different grouping parameters may be employed. As such, it is possible for any one of the number (N) of entries of accounting data to be present in more than one group.

The following Table 1 illustrates an exemplary sorted list of accounting data. In the example of Table 1, the number (N) is eight, meaning that eight entries of accounting data are present. For each of the eight entries of accounting data, the transaction information sub-entry includes a code name of the party involved in the transaction (A or B), the time sub-entry includes a date of transaction, and the transaction amount sub-entry includes the transaction amount including tax. In the sorting operation of step 21, the eight entries of accounting data may be sorted, first based on the code name (in ascending order), and then based on the date of transaction (in ascending order). Then, each of the eight entries of accounting data is assigned a data serial number, thereby completing the sorted list.

TABLE 1

| Data | | | Transaction |
|---|---|---|---|
| Serial | Code | Date of | Amount |
| Number | Name | Transaction | Including Tax |
| 1 | A | 2023 Jan. 1 | 1000 |
| 2 | A | 2023 Jan. 10 | 1000 |
| 3 | A | 2023 Jan. 20 | 5000 |
| 4 | A | 2023 Jan. 23 | 5000 |
| 5 | A | 2023 Jan. 24 | 3000 |
| 6 | A | 2023 Feb. 7 | 3000 |
| 7 | B | 2023 Feb. 20 | 3000 |
| 8 | B | 2023 Feb. 28 | 8000 |

Then, in step 22, two grouping parameters may be present, relating to the code name of the party involved in the transaction and date of transaction, respectively. Specifically, in a case where a plurality of entries of accounting data: a) indicate a same code name; and b) differ in the date of transaction by a predetermined time period (e.g., within 14 days) or less, the processor 13 may put the plurality of entries of accounting data in a same group. The grouping operation may be performed with respect to each of the entries of accounting data, from the one with the data serial number 1 to the one with the data serial number 8.

The following Table 2 lists the groups that are created using the sorted list of Table 1. To elaborate, the grouping operation may be first performed with respect to the entry of accounting data with the data serial number 1, and the entry of accounting data with the data serial number 2 is considered to involve the same party (A) and have the date of transaction being within 14 days with respect to the date of transaction of the entry of accounting data with the data serial number 1. Then, since the entry of accounting data with the data serial number 3 indicates a date of transaction that is more than 14 days apart from the date of transaction of the entry of accounting data with the data serial number 1, the entries 1 and 3 cannot be put in a same group. As a result, a group containing the entries of accounting data with the data serial numbers 1 and 2 is created, and a difference between an earliest date of transaction and a latest date of transaction in the group (represented using the term “date gap” hereinafter) is within the predetermined time period.

Then, with respect to the entry of accounting data with the data serial number 2, both the entry of accounting data with the data serial number 3 and the entry of accounting data with the data serial number 4 are considered to involve the same party (A) and with the dates of transaction being within 14 days with respect to the date of transaction of the entry of accounting data with the data serial number 2. As a result, two groups (i.e., a group containing the entries of accounting data with the data serial numbers 2 and 3, and a group containing the entries of accounting data with the data serial numbers 2, 3 and 4) are created. In the above manner, a total of 8 groups may be created.

TABLE 2

| Group Serial | Data Serial | Date |
|---|---|---|
| Number | Number | Gap |
| A1 | 1, 2 | 9 |
| A2 | 2, 3 | 10 |
| A3 | 2, 3, 4 | 13 |
| A4 | 3, 4 | 3 |
| A5 | 3, 4, 5 | 4 |
| A6 | 4, 5 | 1 |
| A7 | 5, 6 | 14 |
| B1 | 7, 8 | 8 |

Then, in step 23, for each of the groups created in step 22, the processor 13 determines whether the entries of accounting data included in the group indicate a date gap smaller than a predetermined time threshold. When it is determined that the entries of accounting data included in the group indicate a date gap smaller than the predetermined time threshold, the processor 13 tags the group as a candidate group, and tags each of the entries of accounting data included in the candidate group as a potential split entry, and stores the potential split entry in a register list of the data storage 11.

Specifically, the predetermined time threshold may be preset by the user, and the predetermined time threshold may be represented using different units such as days, hours, minutes, or seconds.

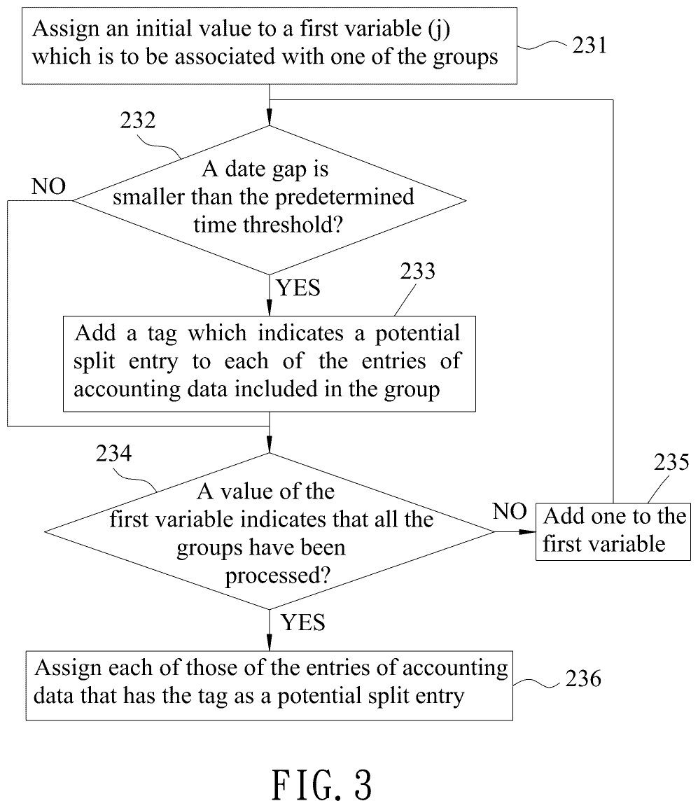

FIG. 3 is a flow chart illustrating exemplary sub-steps of the operations of step 23 according to one embodiment of the disclosure.

In sub-step 231, the processor 13 assigns an initial value to a first variable (j) which is to be associated with one of the groups. In the very beginning, the initial value is 1, and the first variable is associated with a first one of the groups (e.g., the group with the serial number A1).

Then, in sub-step 232, the processor 13 determines, with respect to the group that is currently associated with the first variable, whether the entries of accounting data included in the group indicate a date gap smaller than the predetermined time threshold. That is to say, the processor 13 determines whether a difference between an earliest date of transaction and a latest date of transaction included in the group is smaller than the predetermined time threshold. In a case where the determination of sub-step 232 is affirmative, the flow proceeds to sub-step 233. Otherwise, the flow proceeds to sub-step 234.

In sub-step 233, the processor 13 adds a tag which indicates a potential split entry to each of the entries of accounting data included in the group.

In sub-step 234, the processor 13 determines whether the value of the first variable indicates that all the groups have been processed. Specifically, the processor 13 may determine whether the value of the first variable equals the number (M). In a case where the determination of sub-step 234 is affirmative, the flow proceeds to sub-step 236. Otherwise, the flow proceeds to sub-step 235.

In sub-step 235, the processor 13 adds one to the first variable (which at this stage may be 1). Then, the flow goes back to sub-step 232.

In sub-step 236, the processor 13 assigns each of those of the entries of accounting data that has the tag as a potential split entry.

The following Table 3 lists the exemplary potential split entries after the exemplary groups of the Table 2 are processed by the operations of step 23. It is noted that in this example, the predetermined time threshold is nine days. In the example of Table 3, the groups A1, A4, A5, A6 and B1 are designated as candidate groups.

TABLE 3

| Group Serial | Data Serial Number for |
|---|---|
| Number | Potential Split Entry |
| A1 | 1, 2 |
| A2 | none |
| A3 | none |
| A4 | 3, 4 |
| A5 | 3, 4, 5 |
| A6 | 4, 5 |
| A7 | none |
| B1 | 7, 8 |

After the operations of step 23, the processor 13 performs a filtering operation on the potential split entries in each of the candidate groups, so as to obtain a number of confirmed split entries. In embodiments, based on different criteria, the filtering operation may be performed in step 24, in which the processor 13 performs the filtering operation based on a number of entries, or may be performed in step 24′, in which the processor 13 performs the filtering operation based on an accumulated amount of transaction. It is noted that in some embodiments, the processor 13 may directly assign each of the potential split entries as a confirmed split entry, that is to say, the operation of step 24 or step 24′ may be omitted.

In step 24, the processor 13, with respect to each of the candidate groups, determines whether a number of the potential split entries included in the candidate group is greater than a predetermined entry threshold, and in a case where the number of the potential split entries included in the candidate group is greater than the predetermined entry threshold, adds a tag which indicates a confirmed split entry to each of the potential split entries included in the candidate group.

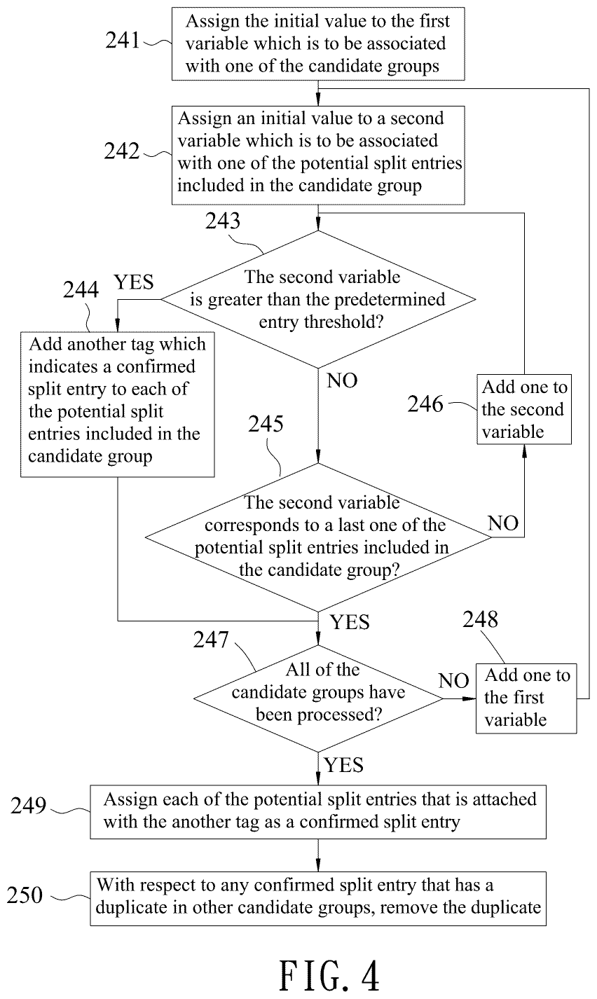

FIG. 4 is a flow chart illustrating exemplary sub-steps of the operations of step 24 according to one embodiment of the disclosure. In this embodiment, a number (K) of candidate groups are present, M≥K≥1, a k^{th} one of the candidate groups includes a number Lₖ of potential split entries, N≥Lₖ≥1, k={1, 2, . . . , K}.

In sub-step 241, the processor 13 assigns the initial value to the first variable (j) which is to be associated with one of the candidate groups. In the very beginning, the initial value is 1, and the first variable is associated with a first one of the candidate groups (e.g., the group with the serial number A1).

In sub-step 242, the processor 13 assigns an initial value to a second variable (i) which is to be associated with one of the potential split entries included in the candidate group. In the very beginning, the initial value is 1, and the second variable is associated with a first one of the potential split entries included in the candidate group indicated by the first variable (e.g., the entry with the serial number 1).

In sub-step 243, the processor 13 determines whether the second variable is greater than the predetermined entry threshold. In a case where the determination of sub-step 243 is affirmative, the flow proceeds to sub-step 244. Otherwise, the flow proceeds to sub-step 245.

In sub-step 244, the processor 13 adds another tag which indicates a confirmed split entry to each of the potential split entries included in the candidate group. Then, the flow proceeds to sub-step 247.

In step 245, the processor 13 determines whether the second variable corresponds to a last one of the potential split entries included in the candidate group. Specifically, the processor 13 determines whether the second variable is equal to the number Lj (i.e., the total number of potential split entries included in the candidate group indicated by the first variable). In a case where the determination of sub-step 245 is affirmative, the flow proceeds to sub-step 247. Otherwise, the flow proceeds to sub-step 246.

In sub-step 246, the processor 13 adds one to the second variable (which at this stage may be 1). Then, the flow goes back to sub-step 243.

In sub-step 247, the processor 13 determines whether all of the candidate groups have been processed. Specifically, the processor 13 determines whether the first variable is equal to the number K. In a case where the determination of sub-step 247 is affirmative, the flow proceeds to sub-step 249. Otherwise, the flow proceeds to sub-step 248.

In sub-step 248, the processor 13 adds one to the first variable (which may initially be 1). Then, the flow goes back to sub-step 242.

In sub-step 249, the processor 13 assigns each of the potential split entries that is attached with the another tag as a confirmed split entry.

Then, in sub-step 250, with respect to any confirmed split entry that has a duplicate in other candidate groups, the processor 13 removes the duplicate.

The following Table 4 lists all the confirmed split entries that are obtained using the filtering operation in the above-described step 24. In the example of Table 4, the predetermined entry threshold is three.

TABLE 4

| Data | | | Transaction |
|---|---|---|---|
| Serial | Code | Date of | Amount |
| Number | Name | Transaction | Including Tax |
| 3 | A | 2023 Jan. 20 | 5000 |
| 4 | A | 2023 Jan. 23 | 5000 |
| 5 | A | 2023 Jan. 24 | 3000 |

Alternatively, in step 24′, with respect to each of the candidate groups, the processor 13 determines whether an accumulated amount of transaction of all of the potential split entries included in the candidate group has exceeded a transaction amount threshold, and in a case where the accumulated amount of transaction of all of the potential split entries has exceeded the transaction amount threshold, adds a tag which indicates a confirmed split entry on each of the potential split entries included in the candidate group.

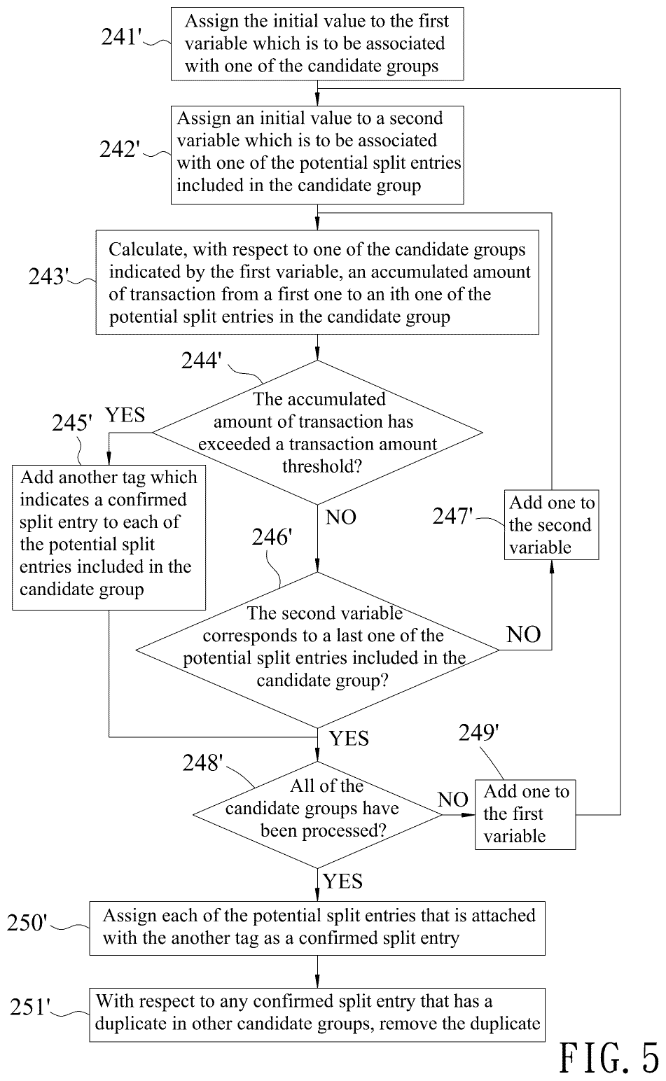

FIG. 5 is a flow chart illustrating exemplary sub-steps of the operations of step 24′ according to one embodiment of the disclosure. In this embodiment, a number (K) of candidate groups are present, M≥K≥1, a k^{th} one of the candidate groups includes a number Lₖ of potential split entries, N≥Lₖ≥1, k={1, 2, . . . , K}.

In sub-step 241′, the processor 13 assigns the initial value to the first variable (j) which is to be associated with one of the candidate groups. In the very beginning, the initial value is 1, and the first variable is associated with a first one of the candidate groups (e.g., the group with the serial number A1).

In sub-step 242′, the processor 13 assigns an initial value to the second variable (i) which is to be associated with one of the potential split entries included in the candidate group. In the very beginning, the initial value is 1, and the second variable is associated with a first one of the potential split entries included in the candidate group indicated by the first variable (e.g., the entry with the serial number 1).

In sub-step 243′, the processor 13 calculates, with respect to one of the candidate groups indicated by the first variable, an accumulated amount of transaction from a first one to an i^{th} one of the potential split entries in the candidate group. In this embodiment, the processor 13 may use the following equation to calculate the accumulated amount of transaction, which is represented by Sum:

$$Sum = {\sum }_{y = 1}^{i} {x}_{y}$$

where x_{y} represents the amount of transaction of a y^{th} one of the potential split entries.

Then, in sub-step 244′, the processor 13 determines whether the accumulated amount of transaction calculated in sub-step 243′ has exceeded a transaction amount threshold. In a case where the determination of sub-step 244′ is affirmative, the flow proceeds to sub-step 245′. Otherwise, the flow proceeds to sub-step 246′.

In sub-step 245′, after it is determined that the accumulated amount of transaction has exceeded the transaction amount threshold, the processor 13 adds another tag which indicates a confirmed split entry to each of the potential split entries included in the candidate group.

In sub-step 246′, the processor 13 determines whether the second variable corresponds to a last one of the potential split entries included in the candidate group. Specifically, the processor 13 determines whether the second variable is equal to the number Lj (i.e., the total number of potential split entries included in the candidate group indicated by the first variable). In a case where the determination of sub-step 246′ is affirmative, the flow proceeds to sub-step 248′. Otherwise, the flow proceeds to sub-step 247′.

In sub-step 247′, the processor 13 adds one to the second variable (which may initially be 1). Then, the flow goes back to sub-step 243′.

In sub-step 248′, the processor 13 determines whether all of the candidate groups have been processed. Specifically, the processor 13 determines whether the first variable is equal to the number K. In a case where the determination of sub-step 248′ is affirmative, the flow proceeds to sub-step 250′. Otherwise, the flow proceeds to sub-step 249′.

In sub-step 249′, the processor 13 adds one to the first variable (which at this stage may be 1). Then, the flow goes back to sub-step 242′.

In sub-step 250′, the processor 13 assigns each of those of the potential split entries that is attached with the another tag as a confirmed split entry.

Then, in sub-step 251′, with respect to any confirmed split entry that has a duplicate in different candidate groups, the processor 13 removes the duplicate.

The following Table 5 illustrates the confirmed split entries that are assigned in sub-step 250′ using the example of Table 1. In this example, the transaction amount threshold is 9999.

TABLE 5

| Data | | | Transaction |
|---|---|---|---|
| Serial | Code | Date of | amount |
| number | name | transaction | including tax |
| 3 | A | 2023 Jan. 20 | 5000 |
| 4 | A | 2023 Jan. 23 | 5000 |
| 3 | A | 2023 Jan. 20 | 5000 |
| 4 | A | 2023 Jan. 23 | 5000 |
| 5 | A | 2023 Jan. 24 | 3000 |
| 7 | B | 2023 Feb. 20 | 3000 |
| 8 | B | 2023 Feb. 28 | 8000 |

The following Table 6 illustrates the confirmed split entries after removing the duplicates in sub-step 251′.

TABLE 6

| Data | | | Transaction |
|---|---|---|---|
| Serial | | Date of | amount |
| number | Code name | transaction | including tax |
| 3 | A | 2023 Jan. 20 | 5000 |
| 4 | A | 2023 Jan. 23 | 5000 |
| 5 | A | 2023 Jan. 24 | 3000 |
| 7 | B | 2023 Feb. 20 | 3000 |
| 8 | B | 2023 Feb. 28 | 8000 |

Following step 24 or step 24′, the flow goes to step 25, where the processor 13 controls the display 12 to display the confirmed split entries and/or the groups. The confirmed split entries and/or the groups may be displayed to alert a user of potential transaction splitting activities associated with the parties involved in the entries of the accounting data.

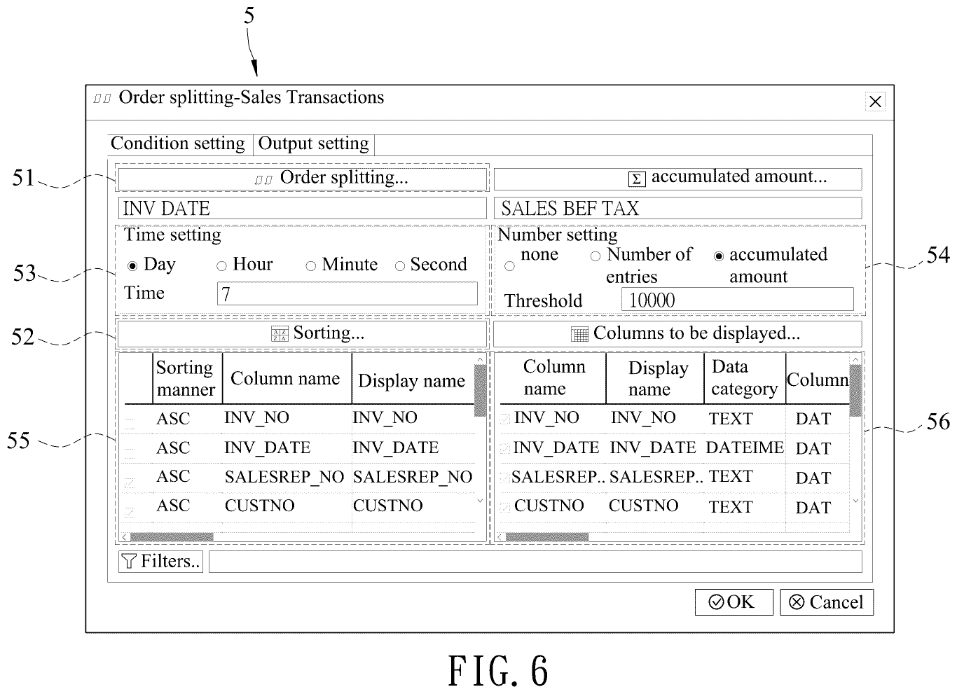

FIG. 6 illustrates a graphical user interface 5 that may be displayed by the display 12 according to one embodiment of the disclosure. In this embodiment, the graphical user interface 5 includes a plurality of setting blocks that enable a user to adjust a number of thresholds. In use, the user may operate an interface (e.g., a keyboard/mouse, a touchscreen, etc.) to adjust the thresholds. In the embodiment of FIG. 6, the graphical user interface 5 includes a group setting block 51, a sorting setting block 52, a date gap setting block 53, a filtering setting block 54, a group displaying setting block 55, and an entry displaying setting block 56.

In the embodiment of FIG. 6, the group setting block 51 enables the user to adjust how the entries of accounting data are to be grouped (e.g., using the date of transaction). The sorting setting block 52 enables the user to adjust parameters based on which the entries of accounting data are to be sorted (e.g., what parameters are to be used for sorting, such as the vendor number). The date gap setting block 53 enables the user to set the predetermined time threshold associated with the date gap (which is seven days in the example of FIG. 6). The filtering setting block 54 enables the user to adjust how the filtering operation is to be performed. For example, the filtering setting block 54 can be used to define whether the filtering operation is to be performed at all (the filtering operation may be omitted), which of the filtering operations of step 24 and step 24′ is to be performed, and the values of the predetermined entry threshold and the transaction amount threshold. The group displaying setting block 55 and the entry displaying setting block 56 enable the user to set how the groups and the confirmed split entries are to be displayed.

To sum up, embodiments of the disclosure provide a method and a system for auditing to detect transaction splitting activities. In the method, a plurality of entries of accounting data are sorted and grouped into a number (M) of groups of accounting data. Then, for each of the groups, a determination as to whether the entries of accounting data included in the group indicate a date gap smaller than a predetermined time threshold is made, so as to decide whether to designate the entries of accounting data as confirmed split entries, which may be involved in potential transaction splitting activities. In some embodiments, a filtering operation may be further implemented to locate the confirmed split entries by comparing a number of potential split entries included in each candidate group with a predetermined entry threshold, or by comparing an accumulated amount of transaction of the potential split entries included in each candidate group with a transaction amount threshold. As such, the confirmed split entries and/or the groups may be more accurately located and displayed so as to notify the user of potential transaction splitting activities associated with the parties involved in the entries of the accounting data. In this manner, the user may further analyze the confirmed split entries and/or the groups that are detected and displayed using the method, and therefore may determine whether actual transaction splitting activities are present. By focusing on other information included in the entries of accounting data, other effects (e.g., preventing employees from an organization or a company from leaking classified information using smaller orders, preventing accumulated inventory due to excessive purchasing within a short time period from happening, etc.) may also be achieved using the method. The method may be particularly useful in cases where the number of entries of accounting is very large.

In the description above, for the purposes of explanation, numerous specific details have been set forth in order to provide a thorough understanding of the embodiment(s). It will be apparent, however, to one skilled in the art, that one or more other embodiments may be practiced without some of these specific details. It should also be appreciated that reference throughout this specification to “one embodiment,” “an embodiment,” an embodiment with an indication of an ordinal number and so forth means that a particular feature, structure, or characteristic may be included in the practice of the disclosure. It should be further appreciated that in the description, various features are sometimes grouped together in a single embodiment, figure, or description thereof for the purpose of streamlining the disclosure and aiding in the understanding of various inventive aspects; such does not mean that every one of these features needs to be practiced with the presence of all the other features. In other words, in any described embodiment, when implementation of one or more features or specific details does not affect implementation of another one or more features or specific details, said one or more features may be singled out and practiced alone without said another one or more features or specific details. It should be further noted that one or more features or specific details from one embodiment may be practiced together with one or more features or specific details from another embodiment, where appropriate, in the practice of the disclosure.

While the disclosure has been described in connection with what is (are) considered the exemplary embodiment(s), it is understood that this disclosure is not limited to the disclosed embodiment(s) but is intended to cover various arrangements included within the spirit and scope of the broadest interpretation so as to encompass all such modifications and equivalent arrangements.

What is claimed is:

1. A method for auditing to detect transaction splitting activities, the method to be implemented using a system that includes a processor and a data storage, the data storage storing a plurality of entries of accounting data therein, each of the plurality of entries of accounting data including at least a transaction information sub-entry and a time sub-entry, the method comprising:
a) performing, by the processor, a sorting operation on the plurality of entries of accounting data stored in the data storage based on the time sub-entry, so as to create a sorted list of accounting data;
b) performing, by the processor, a grouping operation on the sorted list of accounting data, based on at least one grouping parameter and the transaction information sub-entries of the plurality of entries of accounting data, so as to obtain a plurality of groups of accounting data; and
c) with respect to each of the groups, by the processor, determining whether the entries of accounting data included in the group indicate a date gap smaller than a predetermined time threshold, and in a case where the entries of accounting data included in the group indicate a date gap smaller than the predetermined time threshold, tagging the group as a candidate group, and tagging each of the entries of accounting data included in the candidate group as a potential split entry.

2. The method of claim 1, wherein step c) includes:
c-1) with respect to each of the groups, determining, by the processor, whether a difference between an earliest date of transaction and a latest date of transaction included in the group is smaller than the predetermined time threshold; and
c-2) in a case where the determination of sub-step c-1) is affirmative, adding, by the processor, a tag which indicates a potential split entry to each of the entries of accounting data included in the group.

3. The method of claim 1, wherein in step c), a plurality of candidate groups are tagged, the method further comprising:
d) with respect to each of the candidate groups, by the processor, determining whether a number of potential split entries included in the candidate group is greater than a predetermined entry threshold, and in a case where the number of potential split entries included in the candidate group is greater than the predetermined entry threshold, adding a tag which indicates a confirmed split entry to each of the potential split entries included in the candidate group.

4. The method of claim 3, wherein step d) includes:
d-1) assigning an initial value to a variable which is to be associated with one of the potential split entries included in the candidate group;
d-2) determining whether the variable has reached the predetermined entry threshold;
d-3) in a case where the determination of sub-step d-2) is affirmative, adding the tag to each of the potential split entries included in the candidate group;
d-4) in a case where the determination of sub-step d-2) is negative, determining whether a current value of the variable equals a total number of the potential split entries included in the candidate group;
d-5) in a case where the determination of sub-step d-4) is negative, adding one to the variable and repeating sub-step d-2);
d-6) in a case where the determination of sub-step d-4) is affirmative, assigning each of the potential split entries that is attached with the tag as a confirmed split entry; and
d-7) with respect to any confirmed split entry that has a duplicate in other candidate groups, removing the duplicate of the confirmed split entry.

5. The method of claim 1, each of the plurality of entries of accounting data further including a transaction amount sub-entry, wherein in step c), a plurality of candidate groups are tagged as candidate groups, the method further comprising: d′) with respect to each of the candidate groups, by the processor, determining whether an accumulated amount of transaction of all of the potential split entries included in the candidate group has exceeded a transaction amount threshold, and in a case where the accumulated amount of transaction of all of the potential split entries has exceeded the transaction amount threshold, adding a tag which indicates a confirmed split entry to each of the potential split entries included in the candidate group.

6. The method of claim 5, wherein step d′) includes:
d-1′) assigning an initial value to a variable which is to be associated with one of the potential split entries included in the candidate group;
d-2′) calculating an accumulated amount of transaction from a first one to a variable-associated one of the potential split entries included in the candidate group;
d-3′) determining whether the accumulated amount of transaction calculated in sub-step d-2′) has exceeded the transaction amount threshold;
d-4′) in a case where the determination of sub-step d-3′) is affirmative, adding the tag to each of the potential split entries included in the candidate group;
d-5′) in a case where the determination of sub-step d-3′) is negative, determining whether the variable corresponds to a last one of the potential split entries included in the candidate group;
d-6′) in a case where the determination of sub-step d-5′) is negative, adding one to the variable and repeating sub-step d-2′);
d-7′) in a case where the determination of sub-step d-5′) is affirmative, assigning each of the potential split entries that is attached with the tag as a confirmed split entry; and
d-8′) with respect to any confirmed split entry that has a duplicate in other candidate groups, removing the duplicate of the confirmed split entry.

7. A system for auditing to detect transaction splitting activities, the system comprising a processor and a data storage connected to the processor, the data storage storing a plurality of entries of accounting data therein, each of the plurality of entries of accounting data including at least a transaction information sub-entry and a time sub-entry, wherein the processor is programmed to:
perform a sorting operation on the plurality of entries of accounting data stored in the data storage based on the time sub-entries of the plurality of entries of accounting data, so as to create a sorted list of accounting data;
perform a grouping operation on the sorted list of accounting data, based on at least one grouping parameter and the transaction information sub-entries of the plurality of entries of accounting data, so as to obtain a plurality of groups of accounting data; and
with respect to each of the groups, determine whether the entries of accounting data included in the group indicate a date gap smaller than a predetermined time threshold, and in a case where the entries of accounting data included in the group indicate a date gap smaller than the predetermined time threshold, tag the group as a candidate group, and tag each of the entries of accounting data included in the candidate group as a potential split entry.

8. The system of claim 7, wherein the processor is further programmed to, with respect to each of the groups:
determine whether the entries of accounting data included in the group indicate a date gap smaller than a predetermined time threshold by determining whether a difference between an earliest date of transaction and a latest date of transaction included in the group is smaller than the predetermined time threshold; and
add a tag which indicates a potential split entry to each of the entries of accounting data included in the group in a case where the difference between the earliest date of transaction and the latest date of transaction included in the group is smaller than the predetermined time threshold.

9. The system of claim 7, wherein the processor is further programmed to:
with respect to each of those of the groups that is tagged as a candidate group, determine whether a number of potential split entries included in the group has reached a predetermined entry threshold, and in a case where the number of potential split entries included in the group has reached the predetermined entry threshold, add a tag which indicates a confirmed split entry to each of the potential split entries included in the group.

10. The method of claim 3, wherein the processor is further programmed to, with respect to each of those of the groups that is tagged as a candidate group:
assign an initial value to a variable which is to be associated with one of the potential split entries included in the group;
determine whether the variable has reached the predetermined entry threshold;
in a case where the variable has reached the predetermined entry threshold, add the tag to each of the potential split entries included in the group;
in a case where the variable has not reached the predetermined entry threshold, determine whether a current value of the variable equals a total number of the potential split entries included in the group;
in a case where the current value of the variable does not equal the total number of the potential split entries included in the group, add one to the variable and repeat the determination of whether the variable has reached the predetermined entry threshold;
in a case where the current value of the variable equals the total number of the potential split entries included in the group, assign each of the potential split entries that is attached with the tag as a confirmed split entry; and
with respect to any confirmed split entry that has a duplicate in another one of those of the groups that is tagged as a candidate group, remove the duplicate of the confirmed split entry.

11. The system of claim 7, each of the plurality of entries of accounting data further including a transaction amount sub-entry, wherein the processor is further programmed to:
with respect to each of those of the groups that is tagged as a candidate group, determine whether an accumulated amount of transaction of all of the potential split entries included in the group has exceeded a transaction amount threshold, and in a case where the accumulated amount of transaction of all of the potential split entries has exceeded the transaction amount threshold, add a tag which indicates a confirmed split entry to each of the potential split entries included in the group.

12. The system of claim 11, wherein the processor is further programmed to, with respect to each of those of the groups that is tagged as a candidate group:
assign an initial value to a variable which is to be associated with one of the potential split entries included in the group;
calculate an accumulated amount of transaction from a first one to a variable-associated one of the potential split entries included in the group;
determine whether the accumulated amount of transaction has exceeded the transaction amount threshold;
in a case where the accumulated amount of transaction has exceeded the transaction amount threshold, add the tag to each of the potential split entries included in the group;
in a case where the accumulated amount of transaction has not exceeded the transaction amount threshold, determine whether the variable corresponds to a last one of the potential split entries included in the group;
in a case where the variable does not correspond to the last one of the potential split entries included in the group, add one to the variable and repeat the calculation of the accumulated amount of transaction from the first one to a variable-associated one of the potential split entries included in the group;
in a case where the variable corresponds to the last one of the potential split entries included in the group, assign each of the potential split entries attached with the tag as a confirmed split entry; and
with respect to any confirmed split entry that has a duplicate in another one of those of the groups that is tagged as a candidate group, remove the duplicate of the confirmed split entry.
